(19) United States
(12) Patent Application Publication
(10) Pub. No.: US 2022/0350742 A1
(43) Pub. Date: Nov. 3, 2022

(54) METHOD FOR MANAGING CACHE, METHOD FOR BALANCING MEMORY TRAFFIC, AND MEMORY CONTROLLING APPARATUS

(71) Applicant: MemRay Corporation, Gyeonggi-do (KR)

(72) Inventors: Sangwon Lee, Daejeon (KR); Youngjong Jung, Seoul (KR)

(21) Appl. No.: 17/464,843

(22) Filed: Sep. 2, 2021

(30) Foreign Application Priority Data
Apr. 30, 2021 (KR) 10-2021-0056295

(51) Int. Cl. G06F 12/0815; G06F 12/121; G06F 12/10

(52) U.S. Cl. CPC G06F 12/0815; G06F 12/121; G06F 12/10; G06F 2212/608

(57) ABSTRACT

A memory controlling apparatus is connected between computing nodes and memory modules. A cache module includes a cache shared by the computing nodes, and a coherence module manages coherence of the cache. Monitoring modules correspond to the memory modules, respectively, and monitors memory traffics of the memory modules, respectively. An address translation module translates an address of a request from the coherence module into an address of a corresponding memory module among the plurality of memory modules. When a cache line replacement request occurs, the coherence module selects a cache line replacement policy based on a result of comparing memory traffic in a target monitoring module during a predetermined period with a threshold, and replace a cache line based on the selected cache line replacement policy.

### CROSS-REFERENCE TO RELATED APPLICATION

This application claims priority to and the benefit of Korean Patent Application No. 10-2021-0056295 filed in the Korean Intellectual Property Office on Apr. 30, 2021, the entire contents of which are incorporated herein by reference.

### BACKGROUND

### (a) Field

The described technology generally relates to a method of managing a cache, a method of balancing memory traffic, and a memory controlling apparatus.

### (b) Description of the Related Art

Computing devices use caches for fast data accesses. The data stored in the cache is managed in units of cache lines, and its size varies depending on definition of a system and is usually between 16 and 256 bytes.

A method in which a multi-core processor or a plurality of computing devices share a memory system having a plurality of memory modules has been proposed. For example, various protocols such as generation Z (Gen-Z) protocol, compute express link (CXL) protocol, cache coherent interconnect for accelerators (CCIX) protocol, or open coherent accelerator processor interface (OpenCAPI) have been proposed. In such a shared memory system, since a plurality of computing nodes (e.g., processing cores, processors, or computing devices) have their local caches and share a memory, a policy for maintaining cache coherency is used.

On the other hand, since the cache is a memory device having a very small size, it is impossible to store all data necessary for the system in the cache. Accordingly, if a new cache line is requested when a storage space of the cache is used up, it is necessary to replace the existing cache line in the cache with a new cache line. However, in the shared memory system, since a lot of memory traffic occur by the plurality of computing nodes, a cache line replacement method in consideration of the characteristics of the shared memory system is required. There is also a need for a method of balancing memory traffic among a plurality of memory modules of the shared memory system.

### SUMMARY

Some embodiments may provide a method or apparatus for replacing a cache line or balancing memory traffic in a shared memory system.

According to an embodiment, a memory controlling apparatus connected between a plurality of computing nodes and a plurality of memory modules may be provided. The memory controlling device may include a cache module, a coherence module, a plurality of monitoring modules, and an address translation module. The cache module may include a cache shared by the plurality of computing nodes, and the coherence module may manage coherence of the cache. The plurality of monitoring modules may correspond to the plurality of memory modules, respectively, and monitor memory traffics of the plurality of memory modules, respectively. The address translation module may translate an address of a request from the coherence module into an address of a corresponding memory module among the plurality of memory modules. When a cache line replacement request occurs, the coherence module may select a cache line replacement policy based on a result of comparing memory traffic in a target monitoring module during a predetermined period with a threshold, and may replace a cache line based on the selected cache line replacement policy, wherein the target monitoring module is a monitoring module corresponding to the coherence module among the plurality of monitoring modules.

In some embodiments, when the memory traffic does not exceed the threshold, the coherence module may select a cache line replacement policy based on a dirty cache line.

In some embodiments, when one or more dirty cache lines exist in the cache, the coherence module may determine the cache line to be replaced from among the one or more dirty cache lines. Further, when no dirty cache line exists in the cache, the coherence module may determine the cache line be replaced from among one or more clean cache lines.

In some embodiments, when the memory traffic exceeds the threshold, the coherence module may select a cache line replacement policy based on a clean cache line.

In some embodiments, when one or more clean cache lines exist in the cache, the coherence module may determine the cache line to be replaced from among the one or more clean cache lines. Further, when no clean cache line exists in the cache, the coherence module may determine the cache line to be replaced from among one or more dirty cache lines.

In some embodiments, when the target monitoring module includes two or more target monitoring modules, the memory traffic may be a highest memory traffic among memory traffics of the two or more target monitoring modules.

In some embodiments, the address translation module may deliver information about the highest memory traffic to the coherence module.

In some embodiments, when the target monitoring module includes two or more target monitoring modules, the memory traffic may be an average of memory traffics of the two or more target monitoring modules.

In some embodiments, the memory traffic may be an average memory access traffic during the predetermined period.

In some embodiments, the memory traffic may include at least one of a write request or a read request.

In some embodiments, a memory apparatus including the above-described memory controlling apparatus and the plurality of memory modules connected to the memory controlling apparatus may be provided.

According to another embodiment, a memory controlling apparatus connected between a plurality of computing nodes and a plurality of memory modules may be provided. The memory controlling device may include a cache module, a plurality of monitoring modules, an address translation module, and a processing core. The cache module may include a cache shared by the plurality of computing nodes. The plurality of monitoring modules may correspond to the plurality of memory modules, respectively, and monitor memory traffics of the plurality of memory modules, respectively. The address translation module may translate an address of a request from the coherence module into an address of a corresponding memory module among the plurality of memory modules. The processing core may activate a balancing mode when there is a target memory module in which a memory traffic during a predetermined period satisfies a predetermined condition among the plurality of memory modules, and control the address translation module to allow a write request to the target memory module to be forwarded to a temporary memory module among the plurality of memory modules in the balancing mode.

In some embodiments, the predetermined condition may include a condition in which the memory traffic exceeds a first threshold.

In some embodiments, the predetermined condition may further include a condition that the memory traffic is a highest memory traffic among memory traffics exceeding the first threshold.

In some embodiments, the processing core may deactivate the balancing mode when the memory traffic of the target memory module does not exceed a second threshold. In this case, the second threshold may be lower than the first threshold.

In some embodiments, in response to deactivation of the balancing mode, the processing core may control the address translation module to allow a write request to the target memory module not to be forwarded to the temporary memory module.

In some embodiments, in response to deactivation of the balancing mode, the processing core may write data written to the temporary memory module in the balancing mode to the target memory module.

In some embodiments, in response to deactivation of the balancing mode, the processing core may write data written to the temporary memory module in the balancing mode to a memory module other than a target memory module among the plurality of memory modules.

In some embodiments, the processing core may deactivate the balancing mode when the memory traffic of the target memory module satisfies a condition different from the predetermined condition.

In some embodiments, a memory apparatus including the above-described memory controlling apparatus and the plurality of memory modules connected to the memory controlling device may be provided.

According to yet another embodiment, a method of managing a cache in a memory controlling apparatus connected between a plurality of computing nodes and a plurality of memory modules may be provided. The method may include monitoring memory traffics of the plurality of memory modules, occurring a cache line replacement request in a cache shared by the plurality of computing nodes, comparing a memory traffic during a predetermined period in a memory module corresponding to the cache among the plurality of memory modules with a threshold, selecting a cache line replacement policy from among a plurality of cache line replacement policies based on a result of comparing the memory traffic with the threshold, and replacing a cache line of the cache based on the selected cache line replacement policy.

According to still another embodiment, a method of balancing memory traffic in a memory controlling apparatus connected between a plurality of computing nodes and a plurality of memory modules may be provided. The method may include monitoring memory traffics of the plurality of memory modules, determining whether there is a target memory module in which memory traffic during a predetermined period satisfies a predetermined condition among the plurality of memory modules, activating a balancing mode when there is the target memory module, and translating an address of a write request to the target memory module to allow the write request to be forwarded to a temporary memory module among the plurality of memory modules in the balancing mode.

### BRIEF DESCRIPTION OF THE DRAWINGS

FIG. 1 is an example block diagram of a computing system according to an embodiment.

FIG. 2 is an example block diagram of a memory controlling device according to an embodiment.

FIG. 3 is an example flowchart of a cache management method according to an embodiment.

FIG. 4 is a diagram for explaining an example of determining memory traffic in a cache management method according to an embodiment.

FIG. 5 is an example block diagram of a computing system according to another embodiment.

FIG. 6 is an example flowchart of a memory traffic balancing method according to another embodiment.

### DETAILED DESCRIPTION OF THE EMBODIMENTS

In the following detailed description, only certain example embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

As used herein, the singular forms “a”, “an” and “the” are intended to include the plural forms as well, unless the context clearly indicates otherwise.

The sequence of operations or steps is not limited to the order presented in the claims or figures unless specifically indicated otherwise. The order of operations or steps may be changed, several operations or steps may be merged, a certain operation or step may be divided, and a specific operation or step may not be performed.

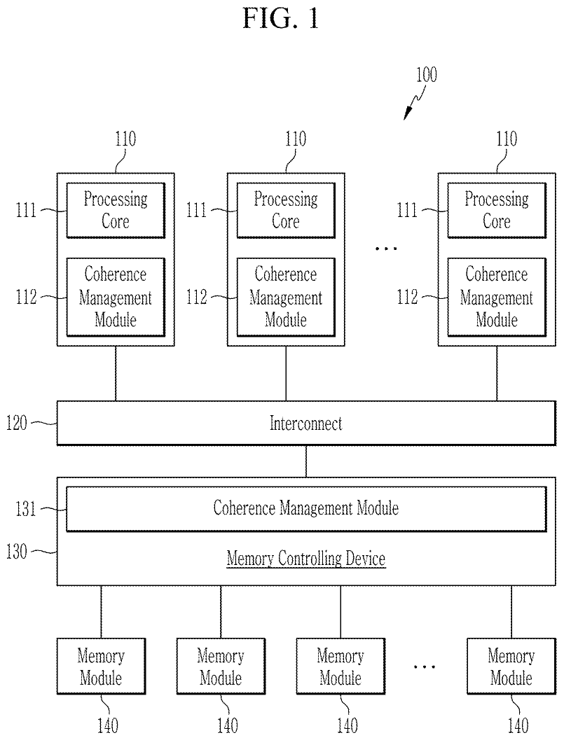

FIG. 1 is an example block diagram of a computing system according to an embodiment.

Referring to FIG. 1, a computing system 100 includes a plurality of computing nodes 110, an interconnect 120, and a memory device (or memory apparatus). The memory device includes a memory controlling device (or memory controlling apparatus) 130 and a plurality of memory modules 140. The memory controlling device 130 allows the plurality of computing nodes 110 to share the plurality of memory modules 140. FIG. 1 shows an example of the computing system 100, and the computing system 100 may be implemented by various structures.

Each computing node 110 may include one or more processing cores 111 as a module for performing computation. Here, the core may mean an instruction processor that reads and executes instructions. In some embodiments, the plurality of computing nodes 110 may be formed in a single chip. In this case, in some embodiments, the single chip may include a multi-core processor having a plurality of processing cores, and each computing node 110 may include one or more processing cores 111 among the plurality of processing cores. In some embodiments, the chip may include a general integrated circuit or system on a chip (SoC). In some embodiments, one or more computing nodes 110 may be included in one chip. In this case, in some embodiments, each computing node 110 may include a computer processor 111 having one or more processing cores.

In some embodiments, the computing node 110 may further include a coherence management module 112. The coherence management module 112 manages a cache line request of the processing core 111 in the corresponding computing node 110. That is, the coherence management module 112 requests a cache line from the memory controlling device 130. In some embodiments, the coherence management module 112 may include a cache shared by the processing cores 111 of the corresponding computing node 110. In this case, the coherence management module 112 may manage cache coherence based on a coherence mechanism to ensure coherency. The coherence mechanism may include, for example, a snooping mechanism, a directory-based mechanism, or a sniffing mechanism. In some embodiments, a level one (L1) cache may be provided for each processing core 111. In this case, the cache of the coherence management module 112 may be a level two (L2) cache.

The processing core 111 of the computing node 110 may transfer an input/output (I/O) request (i.e., a cache line request) of data required during computation to the corresponding coherence management module 112. When a cache line corresponding to an address of the received request exists in an internal cache, the coherence management module 112 may transfer data of the corresponding cache line to the processing core 111. When the cache line corresponding to the address of the received request does not exist in the internal cache, the coherence management module 112 may forward the cache line request to the memory controlling device 130.

The memory controlling device 130 is connected to the plurality of memory modules 140 and controls reads or writes of the memory modules 140. The memory controlling device 130 manages traffics between the plurality of computing nodes 110 and the plurality of memory modules 140 so that the plurality of computing nodes 110 can share the plurality of memory modules 140 for instructions or data. In some embodiments, the plurality of memory modules 140 may serve as a shared memory for the plurality of computing nodes 110.

The memory controlling device 130 includes a coherence management module 131. The coherence management module 131 manages cache line requests from the coherence management modules 112 of the computing nodes 110. The coherence management module 131 may include a cache shared by one or more computing nodes 110. In some embodiments, the cache of the coherence management module 131 may act as an L2 cache with respect to the cache of the coherence management module 112 of the computing node 110. The coherence management module 131 may manage cache coherence based on a coherence mechanism to ensure coherency between the coherence management modules 112 of one or more computing nodes 110. The coherence mechanism may include, for example, a snooping mechanism, a directory-based mechanism, or a snooping mechanism.

In some embodiments, the memory controlling device 130 may further include a memory controller (not shown) for controlling the plurality of memory modules 140.

The interconnect 120 connects the plurality of computing nodes 110 and the memory controlling device 130. In some embodiments, the plurality of computing nodes 110 and the memory controlling device 130 may be included in a single chip. In this case, in some embodiments, the interconnect 120 may include a memory bus. In some embodiments, a chip including the plurality of computing nodes 110 may be connected to the memory controlling device 130 via the interconnect 120. In some embodiments, a plurality of chips including the plurality of computing nodes 110 may be connected to the memory controlling device 130 via the interconnect 120. The interconnect 120 may include, for example, a host interface, Ethernet, or optical network. The host interface may include, for example, a peripheral component interconnect express (PCIe) interface.

Each memory module 140 may include a volatile or non-volatile memory. In some embodiments, the volatile memory may include, for example, DRAM (dynamic random-access memory). In some embodiments, the non-volatile memory may be, for example, a resistance switching memory. In some embodiments, the resistance switching memory may include a phase-change memory (PCM) using a resistivity of a storage medium (phase-change material), for example, a phase-change random-access memory (PRAM), a resistive memory using a resistance of a memory device, for example, a resistive random-access memory (RRAM), or a magnetoresistive memory, for example, a magnetoresistive random-access memory (MRAM). The plurality of computing nodes 110 may access the plurality of memory modules 140 through the memory controlling device 130.

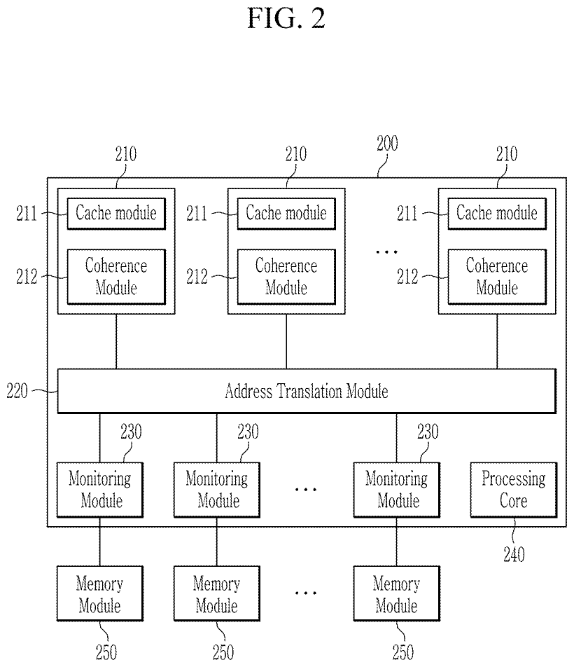

FIG. 2 is an example block diagram of a memory controlling device according to an embodiment.

Referring to FIG. 2, the memory controlling device 200 includes a coherence management module 210, an address translation module 220, and a monitoring module 230. The coherence management module 210 includes a cache module 211 and a coherence module 212. In some embodiments, the memory controlling device 200 may include a plurality of monitoring modules 230 that correspond to the plurality of memory modules 250, respectively. In some embodiments, the memory controlling device 200 may include one or more coherence management modules 210. For convenience of description, a plurality of coherence management modules 210 are shown in FIG. 2. In some embodiments, each coherence management module 210 may correspond to one or more monitoring modules 230 (e.g., one or more memory modules 250) among the plurality of monitoring modules 230.

In some embodiments, the coherence module 212, the address translation module 220, and/or the monitoring module 230 may be implemented in an integrated circuit, for example, a specific block within a chip. In some embodiments, the coherence module 212, the address translation module 220, and/or the monitoring module 230 may be implemented, for example, as part of a microcontroller.

The cache module 211 includes a cache (not shown). The cache module 211 may bring data of the memory module 250 into the cache in units of cache lines, or update (e.g., flush) data in the cache to the memory module 250. When a cache line request (e.g., an input/output (I/O) request of a read request or write request) from a computing node hits to the cache, the cache module 211 may serve the cache line request without accessing the memory module 250. In some embodiments, the cache may be formed in an internal memory of the memory controlling device 200. In some embodiments, the cache module 210 may further include a cache controller (not shown) for controlling a write, read, and release of the cache. The coherence module 212 uses a coherence mechanism to ensure coherency. The coherence module 212 may maintain cache coherence by processing the cache line request from the computing node, for example, a coherence management module of the computing node.

In some embodiments, the coherence mechanism may maintain the cache coherence based on single-writer, multiple-reader (SWMR) invariants. The SWMR invariant may mean that only one computing node having both read and write permissions for a specific cache line exists and one or more computing nodes having only read permission for the specific cache line may exist. For example, when the computing node having the write permission changes a cache line shared by another computing node having the read permission, the corresponding cache line may become dirty.

The address translation module 220 connects the coherence management module 210 with the monitoring module 230. The address translation module 220 receives a memory request for read/write from the coherence management module 210 and converts an address of the memory request into an address of the memory module 250. The address translation module 220 is also called an address translation unit (ATU).

Each monitoring module 230 may monitor memory traffic of a corresponding memory module 250 among a plurality of memory modules 250 connected to the memory controlling device 200. In some embodiments, the monitoring module 230 may periodically monitor the memory traffic of the corresponding memory module 250. In some embodiments, the monitoring module 230 may include a plurality of monitoring modules 230 that correspond to the plurality of memory modules 250, respectively. That is, each memory module 250 may be provided with a monitoring module 230 corresponding thereto.

In some embodiments, the memory traffic of each memory module 250 may include the number of memory accesses in the corresponding memory module 250 during a predetermined period. In some embodiments, the memory traffic of each memory module 250 may include the average number of memory accesses (i.e., average memory access traffic) in the corresponding memory module 250 during the predetermined period. In some embodiments, the memory accesses may include memory reads (read requests) and memory writes (write requests). In some embodiments, the memory accesses may include either the memory reads or the memory writes. In some embodiments, the monitoring module 230 may monitor the memory traffic by counting read requests and/or write requests to the corresponding memory module 250 during the predetermined period. In some embodiments, the monitoring module 230 may include a register that records the counted number of read requests and/or write requests.

The coherence module 212 may read, through the address translation module 220, information of the monitoring module 230 corresponding to the memory module 250 to which addresses managed by the coherence module 212 itself are mapped. The coherence module 212 may change a cache line management policy by comparing the information of the monitoring module 230, for example, the memory traffic with a threshold. In some embodiments, the threshold may be written to a register of the coherence module 212. In some embodiments, the memory controlling device 200 may further include a processing core 240, and the threshold may be set by software through the processing core 240. In some embodiments, the processing core 240 may distribute traffic based on the information of the monitoring module 230, for example, the memory traffic.

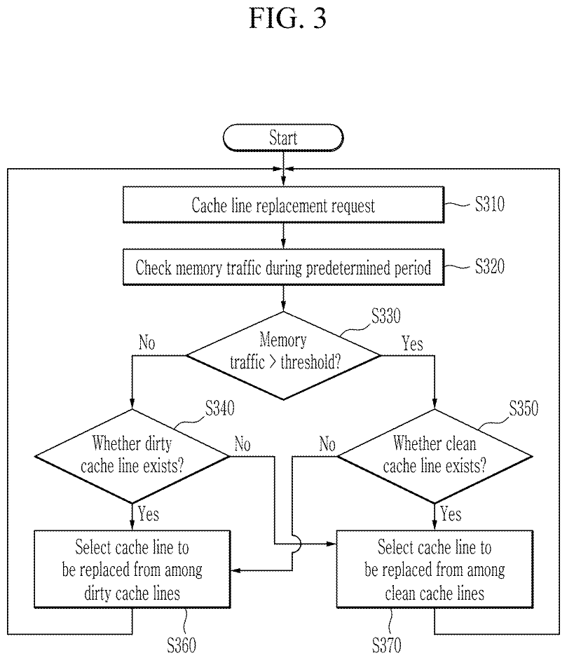

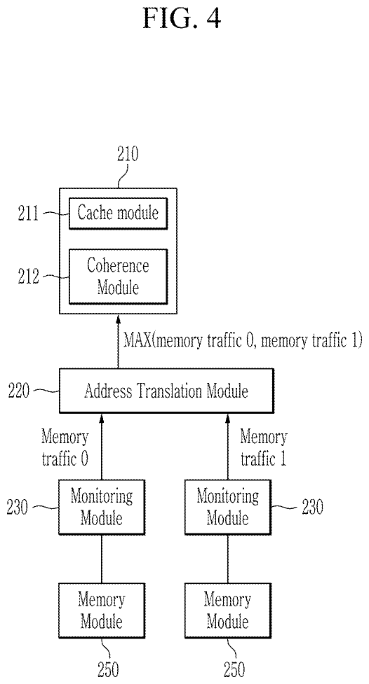

FIG. 3 is an example flowchart of a cache management method according to an embodiment, and FIG. 4 is a diagram for explaining an example of determining memory traffic in a cache management method according to an embodiment.

Referring to FIG. 3, a memory controlling device (e.g., a coherence management module) determines whether a cache line replacement request occurs at S310. In some embodiments, the coherence management module (e.g., 210 of FIG. 2) may request a cache line replacement when a cache of its cache module (e.g., 211 of FIG. 2) is full. When the cache line replacement request occurs, the coherence management module 210 checks memory traffic of a memory module (e.g., 250 of FIG. 2) during a predetermined period through a monitoring module (e.g., 230 of FIG. 2) at S320, and and compares the memory traffic with a threshold at S330. In some embodiments, the coherence management module 210 may bring information (e.g., the memory traffic during the predetermined period) recorded in the corresponding monitoring module 230 among a plurality of monitoring modules through an address translation module (e.g., 220 of FIG. 2). In some embodiments, the memory traffic of each memory module 250 may include the number of memory accesses in the corresponding memory module 250 during the predetermined period. In some embodiments, the memory traffic of each memory module 250 may include the average number of memory accesses (i.e., average memory access traffic) in the corresponding memory module during the predetermined period. In some embodiments, the memory accesses may include memory reads (read requests) and memory writes (write requests). In some embodiments, the memory accesses may include either the memory reads or the memory writes.

In some embodiments, as shown in FIG. 4, when two or more monitoring modules 230 correspond to the coherence management module 210, the coherence management module 210 may compare the highest memory traffic among the memory traffics of the two or more monitoring modules 230 with the threshold. In some embodiments, the address translation module 220 may transfer information about the highest memory traffic among the memory traffics of the two or more monitoring modules 230 to the coherence management module 210.

In some embodiments, when two or more monitoring modules 230 correspond to the coherence management module 210, the coherence management module 210 may use an average of the memory traffics of the two or more monitoring modules as the memory traffic to be compared with the threshold.

The coherence management module 210 may select the cache line replacement policy based on a result of comparing the memory traffic with the threshold. In some embodiments, the cache line replacement policy may be selected from among a plurality of cache line replacement policies including a cache line replacement policy based on a dirty cache line and a cache line replacement policy based on a clean cache line.

When the memory traffic does not exceed the threshold at S330, the coherence management module 210 selects the cache line replacement policy based on the dirty cache line. In some embodiments, when the memory traffic does not exceed the threshold at S330, the coherence management module 210 may determine whether one or more dirty cache lines exist among a plurality of cache lines of the cache module 211 at S340. When the one or more dirty cache lines exist at S340, the coherence management module 210 may select a cache line to be replaced from among the dirty cache lines at S360. In some embodiments, the coherence management module 210 may select a cache line to be replaced from among the dirty cache lines based on one or more of various cache replacement algorithms. The cache replacement algorithms may include, for example, a least recently used (LRU) algorithm, a first in first out (FIFO) algorithm, or a random replacement algorithm. When no dirty cache line exists, the coherence management module 210 may select a cache line to be replaced from among clean cache lines at S370. In some embodiments, the coherence management module 210 may select a cache line to be replaced from among the clean cache lines based on one or more of the various cache replacement algorithms.

When the memory traffic exceeds the threshold at S330, the coherence management module 210 selects the cache line replacement policy based on the clean cache line. In some embodiments, when the memory traffic exceeds the threshold at S330, the coherence management module 210 may determine whether one or more clean cache lines exist among the plurality of cache lines of the cache module 211 at S350. When the one or more clean cache lines exist, the coherence management module 210 may select a replacement cache line from among the clean cache lines at S370. When no clean cache line exists, the coherence management module 210 may select a cache line to be replaced from among dirty cache lines at S360.

In some embodiments, when the memory traffic is equal to the threshold, the coherence management module may perform the operation of either S340 or S350.

In general, when the cache line replacement occurs, the number of traffics to be requested to a memory may vary depending on a state of the cache line to be replaced. When a clean cache line is replaced with a new cache line, one read request may be generated for the memory module because the new cache line is read from the memory module. However, when a dirty cache line is replaced with a new cache line, a write request for writing the dirty cache line to the memory module and a read request for reading the new cache line from the memory module may be generated since the dirty cache line has been updated with a new value,

According to the above-described embodiments, the dirty cache line is replaced when the memory traffic is low, whereas the clean cache line is replaced when the memory traffic is high, so that the traffic due to the cache line replacement can be reduced.

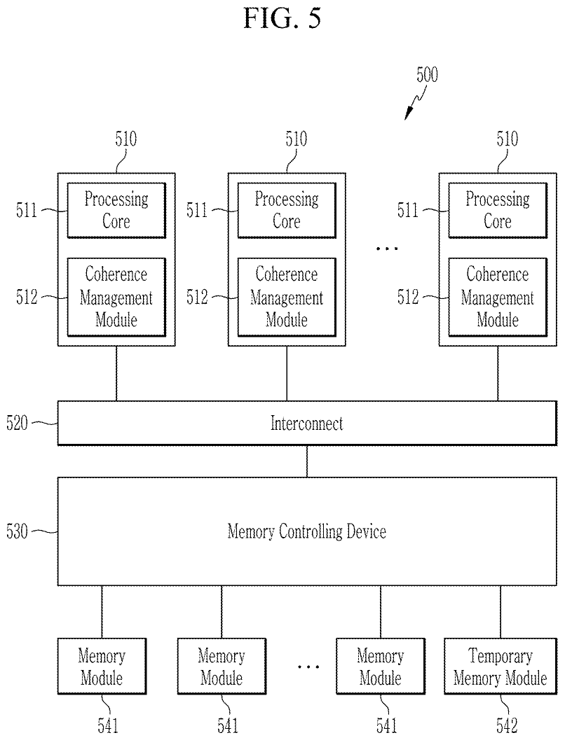

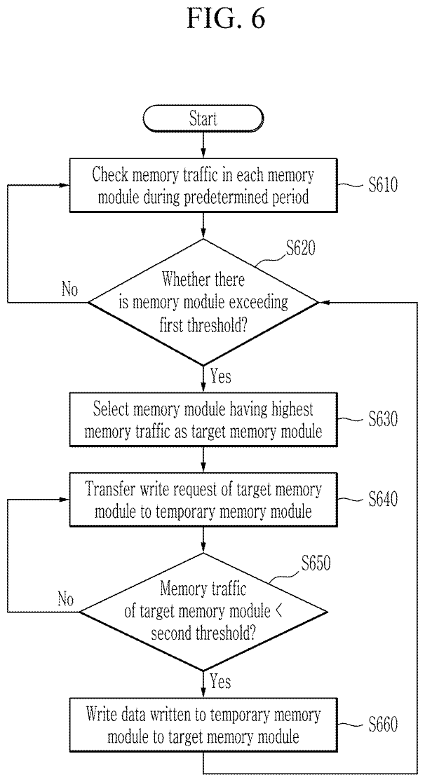

FIG. 5 is an example block diagram of a computing system according to another embodiment, and FIG. 6 is an example flowchart of a memory traffic balancing method according to another embodiment.

Referring to FIG. 5, a computing system 500 includes a plurality of computing nodes 510, an interconnect 520, a memory controlling device 530, and a plurality of memory modules 541 and 542. Since the plurality of computing nodes 510, the interconnect 520, the memory controlling device 530, and the plurality of memory modules 541 and 542 perform the same or similar functions as a plurality of computing nodes 110, an interconnect 120, a memory controlling device 130, and a plurality of memory modules 140 described with reference to FIG. 1, a description thereof is omitted. Unlike embodiments described with reference to FIG. 1, one or more memory modules 542 among the plurality of memory modules 541 and 542 are assigned to a temporary memory module. In some embodiments, the temporary memory module 542 may be a memory area used for memory traffic balancing of the memory controlling device 530, rather than a memory area available to the computing node 510.

In some embodiments, a memory module of the same type as the memory module 541 may be used as the temporary memory module 542. In some embodiments, when a non-volatile memory is used as the memory module 541, another type of memory module having a faster write speed than the memory module 541, for example, DRAM or SRAM may be used as the temporary memory module 542.

Referring to FIG. 5 and FIG. 6, the memory controlling device (e.g., a processing core of the memory controlling device 530) checks memory traffic in each memory module during a predetermined period at S610. In some embodiments, the memory controlling device 530 may bring information (e.g., the memory traffic during a predetermined period) recorded in a plurality of monitoring modules. In some embodiments, for each period, the memory controlling device 530 may check the memory traffic in each memory module during a corresponding period. In some embodiments, the memory traffic in each memory module may include the number of memory accesses in the corresponding memory module during the predetermined period. In some embodiments, the memory traffic in each memory module may include an average number of memory accesses in the corresponding memory module during the predetermined period. In some embodiments, the memory accesses may include memory reads and memory writes. In some embodiments, the memory accesses may include either the memory reads or the memory writes.

The memory controlling device 530 (e.g., a processing core) determines whether there is a memory module 541 in which the memory traffic satisfies a predetermined condition among the plurality of memory modules 541 at S620 and S630. In some embodiments, the predetermined condition may include a condition in which the memory traffic exceeds a threshold. In this case, the memory controlling device 530 (e.g., the processing core) may determine whether there is the memory module 541, in which the memory traffic exceeds a threshold (referred to as an “activation threshold” or a “first threshold”), among the plurality of memory modules 541 at S620. In some embodiments, the predetermined condition may further include a condition in which the memory traffic is highest. In this case, the memory controlling device 530 (e.g., the processing core) may select, as a target memory module 541, the memory module 541 having the highest memory traffic among the memory modules 541 in which the memory traffic exceeds the activation threshold at S630.

When the memory module 541 whose memory traffic exceeds the activation threshold does not exist at S620, the memory controlling device 530 may check the memory traffic again during a next period at S610. In some embodiments, when the memory traffic is equal to the activation threshold, the memory controlling device 530 may perform an operation of either S610 or S630.

In some embodiments, operations of S610 to S630 may be referred to as a memory traffic monitoring mode. As the target memory module 541 is selected in the memory traffic monitoring mode, a memory traffic balancing mode may be activated.

The memory controlling device 530 transfer a write request to the target memory module 541 to a temporary memory module 542 at S640. In some embodiments, the processing core of the memory controlling device 530 may control (or configure) an address translation module so as to allow the write request to the target memory module 541 be transferred to the temporary memory module 542. To this end, the address translation module may translate an address of the write request to the target memory module 541 into an address of the temporary memory module 542. In some embodiments, the memory controlling device 530 may record the address of the temporary memory module 542 to which data of the write request is written in a write update map. In some embodiments, the write update map may be stored in a memory space of the memory controlling device 530. In some embodiments, the memory space may be an internal memory space of the address translation module. In some embodiments, the memory controlling device 530 may store the address of the temporary memory module 542 by mapping it to the address of the actual write request.

Accordingly, when the memory controlling device 530 receives a read request of the data written to the temporary memory module 542, the address translation module may translate an address of the read request to the address of the temporary memory module 542 by referring to the write update map. Accordingly, the memory controlling device 530 may read the data of the read request from the temporary memory module 542. Meanwhile, when receiving the read request for the data written to the target memory before the memory traffic balancing mode is activated, the memory controlling device 530 may read the data of the read request from the target memory module 541. That is, since the address of the read request is not recorded in the write update map, the address translation module may translate the address of the read request into the address of the target memory module 541.

Next, when the memory traffic of the target memory module 541 is lower than another threshold (referred to as an “inactivation threshold” or a “second threshold”) during a certain period at S650, the memory controlling device 530 (e.g., processing core) deactivates the memory traffic balancing mode at S660. In response to deactivation of the memory traffic balancing mode, the memory controlling device 530 (e.g., processing core) stops transferring a write request to the target memory module 541 to the temporary memory module 542, and forwards the write request to the target memory module 541 at S660. The deactivation threshold is set to a value lower than the activation threshold. In some embodiments, the processing core may control (or configure) the address translation module so as to allow a write request to the target memory module 541 not be forwarded to the temporary memory module 542. In some embodiments, the address translation module may translate an address of the write request to the target memory module 541 back to an address of the target memory module 542. In some embodiments, the memory controlling device 530 may perform an operation of writing data written to the temporary memory module 542 to an original address, that is, to the target memory module 541. In some embodiments, the memory controlling device 530 may write the data written to the temporary memory module 542 to a new memory area instead of writing the data to the original address. In this case, the address translation module of the memory controlling device 530 may translate addresses between the new memory area and the original memory area. The address translation module may translate an address connected to the original memory area into an address connected to the new memory area. In some embodiments, the new memory area may be a memory module 541 other than the target memory module 541. Accordingly, it is possible to reduce an access frequency of the target memory module 541 having the high memory access traffic.

As such, the memory controlling device 530 may deactivate the memory traffic balancing mode and perform a data restore mode at S660.

In some embodiments, when the memory traffic of the target memory module 541 does not become lower than the deactivation threshold at S650, the memory controlling device 530 may continue to perform the memory traffic balancing mode. In some embodiments, when the memory traffic of the target memory module 541 is equal to the deactivation threshold, the memory controlling device 530 may perform an operation of either S660 or S640.

In some embodiments, when the operation of the data recovery mode is completed, the memory controlling device 530 may again enter the memory traffic monitoring mode and select a target memory module for the memory traffic balancing mode.

According to above-described embodiments, since processing of requests may be delayed in a specific memory module when traffic of the specific memory module is high, it is possible to prevent the processing of the requests from being delayed by distributing the traffic of the specific memory module. In particular, when a non-volatile memory in which a write is slower than a read is used, processing of write requests can be prevented from being delayed by distributing the write requests to a temporary memory module, and processing of read requests can be prevented from being delayed due to conflicts with the write requests.

While this invention has been described in connection with what is presently considered to be various embodiments, it is to be understood that the invention is not limited to the disclosed embodiments. On the contrary, it is intended to cover various modifications and equivalent arrangements included within the spirit and scope of the appended claims.

What is claimed is:

1. A memory controlling apparatus connected between a plurality of computing nodes and a plurality of memory modules, the apparatus comprising:
a cache module including a cache shared by the plurality of computing nodes;
a coherence module configured to manage coherence of the cache;
a plurality of monitoring modules corresponding to the plurality of memory modules, respectively, and configured to monitor memory traffics of the plurality of memory modules, respectively; and
an address translation module configured to translate an address of a request from the coherence module into an address of a corresponding memory module among the plurality of memory modules,
wherein when a cache line replacement request occurs, the coherence module is configured to select a cache line replacement policy based on a result of comparing memory traffic in a target monitoring module during a predetermined period with a threshold, and replace a cache line based on the selected cache line replacement policy, and wherein the target monitoring module is a monitoring module corresponding to the coherence module among the plurality of monitoring modules.

2. The apparatus of claim 1, wherein when the memory traffic does not exceed the threshold, the coherence module is configured to select a cache line replacement policy based on a dirty cache line.

3. The apparatus of claim 2, wherein when one or more dirty cache lines exist in the cache, the coherence module is configured to determine the cache line to be replaced from among the one or more dirty cache lines, and
wherein when no dirty cache line exists in the cache, the coherence module is configured to determine the cache line be replaced from among one or more clean cache lines.

4. The apparatus of claim 1, wherein when the memory traffic exceeds the threshold, the coherence module is configured to select a cache line replacement policy based on a clean cache line.

5. The apparatus of claim 4, wherein when one or more clean cache lines exist in the cache, the coherence module is configured to determine the cache line to be replaced from among the one or more clean cache lines, and
wherein when no clean cache line exists in the cache, the coherence module is configured to determine the cache line to be replaced from among one or more dirty cache lines.

6. The apparatus of claim 1, wherein when the target monitoring module includes two or more target monitoring modules, the memory traffic is a highest memory traffic among memory traffics of the two or more target monitoring modules.

7. The apparatus of claim 6, wherein the address translation module is configured to deliver information about the highest memory traffic to the coherence module.

8. The apparatus of claim 1, wherein when the target monitoring module includes two or more target monitoring modules, the memory traffic is an average of memory traffics of the two or more target monitoring modules.

9. The apparatus of claim 1, wherein the memory traffic is an average memory access traffic during the predetermined period.

10. The apparatus of claim 1, wherein the memory traffic may include at least one of a write request or a read request.

11. A memory apparatus comprising:
the memory controlling apparatus of claim 1; and
the plurality of memory modules connected to the memory controlling apparatus.

12. A memory controlling apparatus connected between a plurality of computing nodes and a plurality of memory modules, the apparatus comprising:
a cache module including a cache shared by the plurality of computing nodes;
a plurality of monitoring modules corresponding to the plurality of memory modules, respectively, and configured to monitor memory traffics of the plurality of memory modules, respectively;
an address translation module configured to translate an address of a request from the coherence module into an address of a corresponding memory module among the plurality of memory modules; and
a processing core configured to activate a balancing mode when there is a target memory module in which a memory traffic during a predetermined period satisfies a predetermined condition among the plurality of memory modules, and control the address translation module to allow a write request to the target memory module to be forwarded to a temporary memory module among the plurality of memory modules in the balancing mode.

13. The apparatus of claim 12, wherein the predetermined condition includes a condition in which the memory traffic exceeds a first threshold.

14. The apparatus of claim 13, wherein the predetermined condition further includes a condition that the memory traffic is a highest memory traffic among memory traffics exceeding the first threshold.

15. The apparatus of claim 13, wherein the processing core is configured to deactivate the balancing mode when the memory traffic of the target memory module does not exceed a second threshold, and
wherein the second threshold is lower than the first threshold.

16. The apparatus of claim 15, wherein in response to deactivation of the balancing mode, the processing core is configured to control the address translation module to allow a write request to the target memory module not to be forwarded to the temporary memory module.

17. The apparatus of claim 15, wherein in response to deactivation of the balancing mode, the processing core is configured to write data written to the temporary memory module in the balancing mode to the target memory module.

18. The apparatus of claim 15, wherein in response to deactivation of the balancing mode, the processing core is configured to write data written to the temporary memory module in the balancing mode to a memory module other than a target memory module among the plurality of memory modules.

19. The apparatus of claim 12, wherein the processing core is configured to deactivate the balancing mode when the memory traffic of the target memory module satisfies a condition different from the predetermined condition.

20. A memory apparatus comprising:
the memory controlling apparatus of claim 12; and
the plurality of memory modules connected to the memory controlling apparatus.

21. A method of managing a cache in a memory controlling apparatus connected between a plurality of computing nodes and a plurality of memory modules, the method comprising:
monitoring memory traffics of the plurality of memory modules;
occurring a cache line replacement request in a cache shared by the plurality of computing nodes;
comparing a memory traffic during a predetermined period in a memory module corresponding to the cache among the plurality of memory modules with a threshold;
selecting a cache line replacement policy from among a plurality of cache line replacement policies based on a result of comparing the memory traffic with the threshold; and
replacing a cache line of the cache based on the selected cache line replacement policy.

22. A method of balancing memory traffic in a memory controlling apparatus connected between a plurality of computing nodes and a plurality of memory modules, the method comprising:
monitoring memory traffics of the plurality of memory modules;
determining whether there is a target memory module in which memory traffic during a predetermined period satisfies a predetermined condition among the plurality of memory modules;
activating a balancing mode when there is the target memory module; and
translating an address of a write request to the target memory module to allow the write request to be forwarded to a temporary memory module among the plurality of memory modules in the balancing mode.
